(19) United States
(12) Patent Application Publication
(10) Pub. No.: US 2005/0152316 A1
(43) Pub. Date: Jul. 14, 2005

(54) CDMA transmitting and receiving apparatus with multiple applied interface functions and a method thereof

(76) Inventors: Chien-Hsing Liao, Longtan Township (TW); Yueh-Jzong Lee, Taipei City (TW); Shu-Shiuan Ho, Hsinchu City (TW); Wei-Min Chang, Jhongli City (TW); Hsiang-Lin Dai, Yangmei Township (TW); Yao-Shing Huang, Longtan Township (TW)

Correspondence Address: J.C. Patents, Inc., 4 Venture, Suite 250, Irvine, CA, 92618, US

(21) Appl. No.: 10/753,777

(22) Filed: Jan. 8, 2004

(51) Int. Cl. H04B 7/216

(52) U.S. Cl. 370/335; 370/479; 370/342; 370/441

(57) ABSTRACT

A CDMA transmitting and receiving apparatus with multiple applied interface functions and a method thereof is provided. The apparatus is center around a system control unit. The system control unit includes a plurality of interface drivers that works with a base band signal processing unit for converting information of different kinds to a base band signal and then transmits through a communication transceiver. Alternatively, the system control unit also transmits information to at least one of the connecting interfaces when the communication transceiver receives a base band signal. Moreover, the apparatus also provides integration to information of different kinds allowing flexibility and adaptability thereby enabling an efficient and secured use of network management interfaces within a communication system.

### BACKGROUND OF THE INVENTION

1. Field of the Invention

The present invention is generally related to a code division multiple access (CDMA) transmitting and receiving apparatus. More particularly, the present invention relates to a CDMA transmitting and receiving apparatus capable of supporting multiple applied interface functions and a method thereof.

2. Description of the Related Art

Verse Small Aperture Terminal (VSAT) is a common name for a ground microwave station (or an end terminal) establishing a communication link through a satellite. The VSAT applied satellites currently in use are mostly synchronous satellites and each of the synchronous satellites related to earth is only 1.5 degrees space apart. The VSAT technologies not only involves the ground microwave station and other indoor microwave devices, but also includes signal adjustment coding, link budgets, network management and multiple access. The multiple access technologies are used to provide communication access for multiple users at the same time, and are the basis for more and more technologies.

The conventional VSAT multiple access includes three types. They are Frequency Division Multiple Access (FDMA), Time Division Multiple Access (TDMA) and Code Division Multiple Access (CDMA). FDMA is the earliest multiple access type of technologies. FDMA divides frequency bands and uses other related technologies for providing more users to communicate. But, FDMA also causes serious problems producing inter-modulation interferences and channel congestions due to the previous frequency overlapping between the C bands and the ground communication system, frequency overlapping of the bandwidths between the synchronized satellites and lacks of flexibility. Although the present FDMA technologies have moved to high frequency bands in Ku or even Ka for a wider bandwidth, but FDMA still faces a lot of challenges as the communication system is becoming more complicated and improved.

Like FDMA, a conventional TDMA is also a mature multiple access technology. TDMA is mostly used in a VSAT network system. TDMA uses a time slot for a transmission using only one frequency signal for multiple accesses. However, the present TDMA requires a transformation to an adaptive TDMA in order to meet the capacity on demand and the advancement in network software management.

On the other hand, CDMA uses a code division for providing multiple accesses. In recent years, technologies such as mobile phones, low power wireless phones and satellites have grown rapidly due to the advancement in wireless communication technologies. Moreover, the CDMA technologies are more resisting to a noise compared to other conventional transmission technologies. In addition, the CDMA technologies have the advantages in providing multiple accesses with ease, unaffected by the transmissions nearby and low failing rate. It is not surprising that the CDMA technologies have became more popular in the recent years. Moreover, direct sequence CDMA (DS/CDMA) can handle more data at the same time compared to FDMA and TDMA and is easier to control within a network. As a result, CDMA has also become a mainstream in the ground area communication zone and broad communication coverage zone.

As previously described, FDMA faces a lot of challenges due to immaturity of the technology as communication continues to grow and advance. On the other hand, adaptive TDMA attempts to meet the capacity on demand inevitably increases the complexity in software network management. In contrast, direct sequence spread spectrum CDMA (DSSS/CDMA) allows higher network capacity compared to FDMA and TDMA and is easier to control within a network. As a result, CDMA has also become a mainstream in the ground area communication zone and broad communication coverage zone.

At present, CDMA technologies are mainly focused on the principles of the CDMA fundamentals (for example, in the area of spread spectrum communication, spread spectrum coding transmitting and receiving, distribution and apparatus thereof) and application thereof, or implementation on VSAT CDMA systems and MODEM. However, the CDMA technologies and papers have not yet included interfaces for processing input information of different kinds (for example, a fax, a phone, an exchanger and a serial/parallel communication input) and provided an integration in which. Rather, the present CDMA technologies are limited to a user's only applied interface or simple switching between the radio frequency and the base band signals. In the other words, the present CDMA technologies cannot meet the need of a user today through a VSAT CDMA system. Moreover, the present CDMA technologies cannot provide support for a user and an external protected interface connection simultaneously. Furthermore, the present CDMA technologies do not provide an adequate support for an overall communication network management interface that is safe, secure and efficient.

### SUMMARY OF THE INVENTION

The present invention is to provide a CDMA transmitting and receiving apparatus with multiple applied interface functions and a method thereof. The apparatus is able to integrate information inputs of different kinds and provide a more flexible use of the applied interfaces and an expansion thereof.

Another objective of the present invention is to provide a CDMA transmitting and receiving apparatus with multiple applied interface functions and a method thereof. The apparatus is able to utilize the applied interfaces and system resource usage of an overall communication network, which is safe, secure and efficient.

In order to achieve the objectives described above, the present invention provides a CDMA transmitting and receiving apparatus with multiple applied interface functions. The apparatus comprises: a base band signal processing unit; a system control unit; a base band transmitter unit; a base band receiver unit and a system processing unit. The base band signal processing unit is capable of converting a variety of analog or digital input data, either in serial or parallel, to a base band data of CDMA. The input data comprises a voicemail, a fax, an exchanger, a network, an external protected device or a common serial/parallel output device. On the other hand, the system processing unit is capable of providing a reference signal according to a plurality of applied parameters of the system control unit. Wherein, the reference signal is programmable to at least one of the base band signal processing unit, the system control unit capable, the base band transmitter and the base band receiver unit.

The system control unit is capable of setting, changing, monitoring and maintaining a communication link by organizing the base band data according to an outside setting or an internal setting of the apparatus. In addition, the system control unit is capable of integrating a plurality of controllers and a plurality of interface drivers internally and externally to the apparatus.

The base band transmitter unit is capable of framing a code data according to a setting parameter and outputting a base band analog signal to be ready for a radio frequency communication. In addition, the base band transmitter unit incorporates a function for forward error correction and a function for adjusting the bandwidth (or chip length) for a direct sequence spread spectrum. Thus, the base band transmitter unit provides multiple applied functions for multiple users simultaneously.

On the other hand, the base band receiver unit is capable of processing and de-framing a base band analog signal from the outside according to the setting parameter and outputting a base band digital signal to the system control unit. In addition, the base band receiver unit incorporates a function for reverse-forward error correction and a function for re-adjusting the bandwidth for a direct sequence spread spectrum.

As one preferred embodiment of the present invention, the CDMA transmitting and receiving apparatus with multiple applied interface functions further comprises: a radio frequency (RF) transmitter unit and a radio frequency (RF) receiver unit. The radio frequency (RF) transmitter unit is capable of converting the base band analog signal and providing a radio frequency signal for transmitting. The radio frequency transmitter unit is also capable of adjusting a work efficiency of a transmitting signal, setting and selecting a bandwidth within the base band and the radio frequency. In contrast, the radio frequency (RF) receiver unit is capable of receiving the radio frequency signal from the outside and re-converting back to the base band analog signal. In addition, the radio frequency receiver unit is capable of adjusting the gain of the received signal, setting and selecting a bandwidth within the base band and the radio frequency.

The present invention uses a module for design and implementation. In which, the firmware and software programs are designed according to the need and arrangements of the hardware and state machines. The apparatus can be built by using existing chips or by using VSLI manufacturing to meet System on Chip (SOC).

The following descriptions describe and illustrate more fully the objectives, characteristics and advantages of the present invention. It is important to note that an element can be directly connected, indirectly connected or coupled to another element, or connected in between the other elements when the element is referred to as being connected or coupled in the description. On the other hand, an element is not connected in between the other elements when the element is referred to as being directly connected or directly coupled.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates an overall architecture of a CDMA transmitting and receiving apparatus with multiple applied interface functions.

FIG. 1B illustrates a base band transmitter unit, a base band receiver unit, a radio frequency transmitter unit and a radio frequency receiver unit of FIG. 1A as one preferred embodiment of the present invention.

FIG. 1C illustrates a base band signal processing unit of FIG. 1A as another preferred embodiment of the present invention.

FIG. 2 illustrates an architecture of an interface integration driving unit of FIG. 1A as another preferred embodiment of the present invention.

FIG. 3 illustrates states of a state machine controller of FIG. 2 as another preferred embodiment of the present invention.

FIG. 4 shows a flow diagram for a link set state of FIG. 3 as another preferred embodiment of the present invention.

FIG. 5 shows an ESC/CSC information frame and an ESC/CSC macro synchronized information frame as another preferred embodiment of the present invention.

FIG. 6 illustrates a radio frequency CDMA transceiver with multiple functions and a base band CDMA transceiver with multiple functions as another preferred embodiment of the present invention.

FIG. 7 shows an output spread spectrum (F_{c}=140 MHz, FEC=½, Power≅−10 dbm, F_{c,cut}≅4.4 MHz, PN length=512) as another preferred embodiment of the present invention.

FIG. 8 shows an output spread spectrum (F_{c}=140 MHz, FEC=½, Power≅−40 dbm, F_{c,cut}≅4.4 MHz, PN length=512) as another preferred embodiment of the present invention.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

CDMA uses division of codes for providing a multiple access. CDMA spread spectrum uses orthogonal property for separating CDMA codes. What about CDMA system capacity when CDMA is applied in a real implementation? One method for calculating the CDMA system capacity derived from Gaussian theory is as follow:

$${P}_{b} \approx g ( μ ) = Q ( {[ \frac{K - 1}{3 N} + \frac{{N}_{0}}{2 {E}_{b}} ]}^{- 0.5} )$$

As shown from the above formula, the accuracy is very good when the system capacity K (the number of users) is very big. A probability of error P_{b} is not too big even when the value of K is not big. As a result, the probability of error is small when the chip number (chip)N increases. It is important to note, an error function is Q(x)=0.5erf(x/\sqrt{2})≈exp(−x²/2) /(\sqrt{2π}x) when x is very big and at this time Q(3.11)≈10⁻³. Moreover, a simple mathematical formula can be used to estimate CDMA system capacity when the probability of error is 10⁻³ and E_{b}/N₀ is big. The formula is as follow:

$$K < 3 N ( \frac{1}{{3.11}^{2}} - \frac{1}{2 {E}_{b} / {N}_{0}} ) + 1 \approx \frac{N}{3}$$

The above formula is used to estimate a system capacity in designing a CDMA system. In the other words, the system can handle N/3 of users when the required probability of error is greater than 10⁻³ in a direct sequence spread spectrum. The formula derived from Gaussian, as shown in the above, has been frequently used in a scientific publication due to its simplicity and uniqueness.

The previous paragraph demonstrates a simple capacity formula for a CDMA system with multiple users. The present invention is related to a CDMA transmitting and receiving apparatus with multiple applied interface functions and a method thereof. In addition, the present invention uses a module for design and implementation. In which, the firmware and software programs are designed according to the need and arrangements of the hardware and state machines, thus making an overall integration with flexibility for the apparatus.

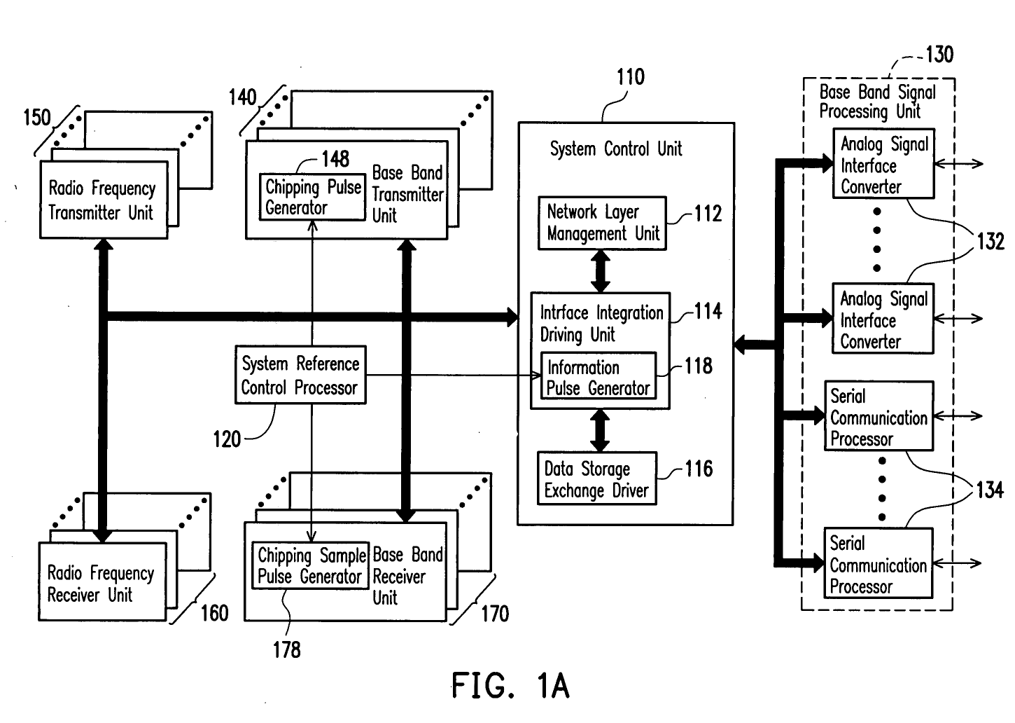

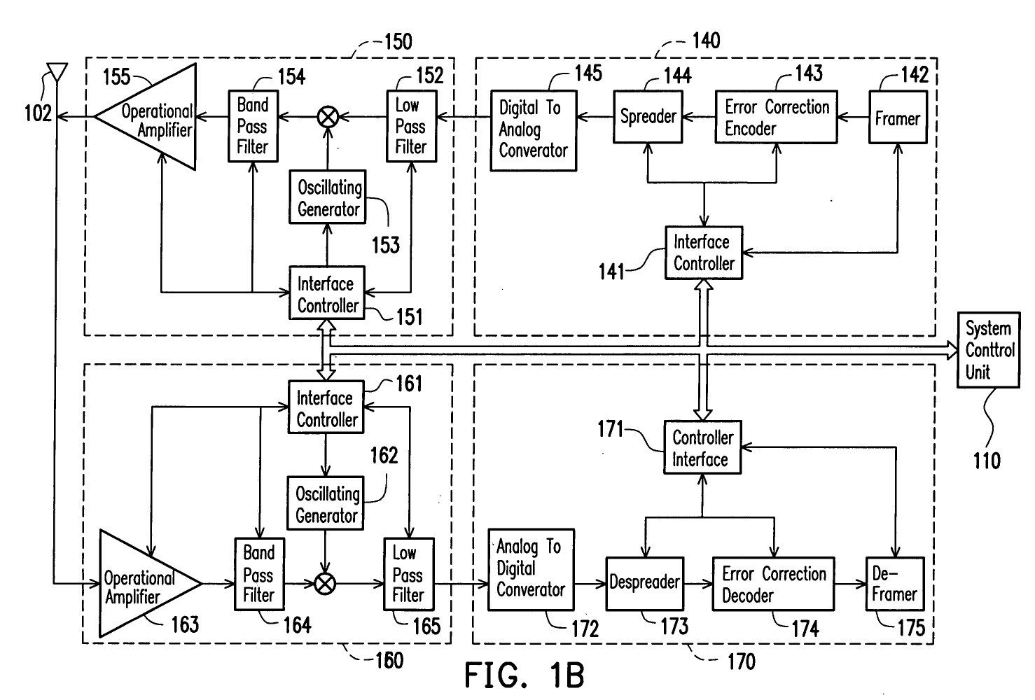

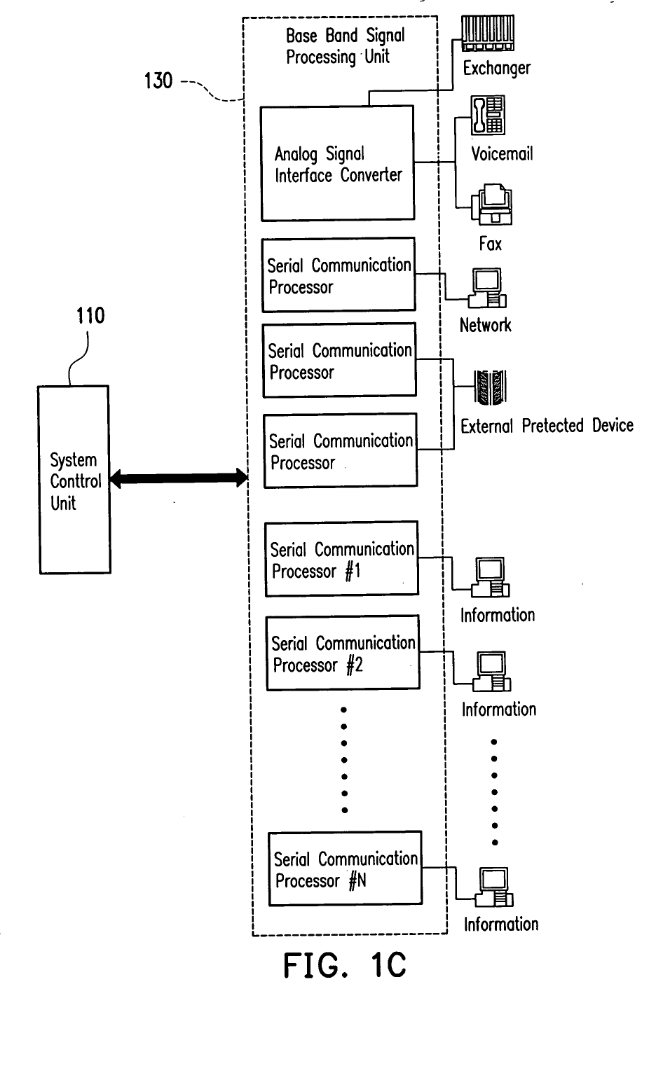

FIG. 1A illustrates an overall architecture of a CDMA transmitting and receiving apparatus with multiple applied interface functions. FIG. 1B illustrates a base band transmitter unit, a base band receiver unit, a radio frequency transmitter unit and a radio frequency receiver unit of FIG. 1A as one preferred embodiment of the present invention. FIG. 1C illustrates a base band signal processing unit of FIG. 1A as another preferred embodiment of the present invention.

Referring to FIG. 1A, FIG. 1B and FIG. 1C, a base band signal processing unit 130 is capable of converting a variety of analog or digital input data, either in serial or parallel, to a data accepted by a base band transmitter unit 140. The input data includes a voicemail, a fax, an exchanger, a network, an external protected device or a common serial/parallel output device. The base band signal processing unit 130 is therefore includes two parts: an analog converter and a digital converter. The analog signal interface converter 132 is used in converting a signal from the voicemail, the fax, the exchanger and other analog signals to a specified format of digital data according to a pre-defined set or designed architecture. On the other hand, the serial communication processor 134 is used in converting a data from the network, the external protected device, the common serial/parallel output device (for example, a MUX) or other digital signals also to the specified format of digital data according to the pre-defined set or designed architecture.

The system control unit 110 is capable of setting, changing, monitoring and maintaining a communication link by organizing the base band data according to an outside setting or an internal setting of the apparatus. In addition, the system control unit is capable of integrating: any interface related driver unit; interface related controllers for an external multiple applied functions base band transceiver; interface related controllers for an external multiple applied functions radio frequency transceiver; an external timing control processor, and a data storage exchange. The system control unit 110 includes a network layer management unit 112, an interface integration driving unit 114 and a data storage exchange unit 116. The network layer management unit 112 is capable of setting, changing, monitoring and maintaining the communication link of the interface integration driving unit 114 according to a parameter from an external network management system. The interface integration driving unit 114 is capable of integrating a plurality of interfaces of the apparatus according to an internal setting thereby setting, changing, monitoring and maintaining the communication link. The data storage exchange unit 116 is capable of exchanging parameters of the interfaces of the apparatus, and transmitting and exchanging network information.

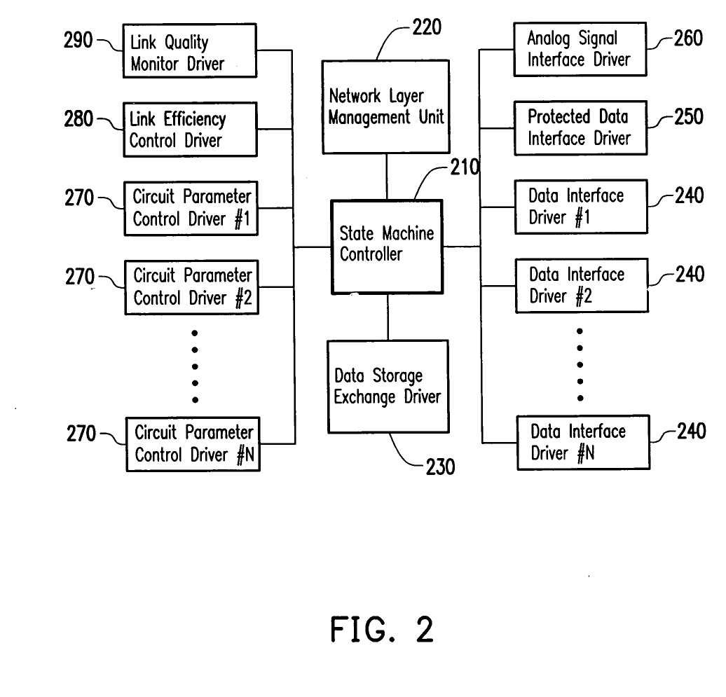

FIG. 2 illustrates an architecture of the interface integration driving unit of FIG. 1 A as another preferred embodiment of the present invention. Referring to FIG. 2, the interface integration driving unit 114 includes a state machine controller 210 and various kinds of interface drivers 220˜290. The state machine controller 210 gathers and integrates information of different kinds from the various interface drivers 220-290. In addition, the state machine controller 210 is capable of setting and controlling the interface drivers 220-290 and states thereof, and avoiding an unstable state and a transient state from happening caused by the multiple applied interfaces thereby maintaining an overall system stability. A network layer management driver 220 provides an interface break signal and data-driving capability after a parameter of the external network management system is set. On the other hand, a data storage exchange driver 230 provides another interface break signal and data-driving capability after parameters exchange between any corresponding interfaces, network management information transmission, and information data transmission and exchange. Moreover, an analog signal interface driver 260 provides another interface break signal and also data-driving capability after converting a data from the voicemail, the fax, and the exchanger to the specified format of digital data according to the pre-defined set or designed architecture.

Furthermore, a protected data interface driver 250 provides another interface break signal for a protected data after receiving (before decoding) or a data before transmission. The protected data interface driver 250 also provides data-driving capability. The protected data or a data before transmission and data-driving capability are done after a data is being converted to the specified format of digital data according to the pre-defined set or designed architecture. Moreover, a data interface driver 240 provides another interface break signal and data-driving capability after converting, for example, a conventional serial or parallel digital data (or with an additional MUX or by using a time division multiplex TDM) to the specified format of digital data according to the pre-defined set or designed architecture. Moreover, a circuit parameter control driver 270 provides another interface break signal and data-driving capability for an interface controller. Moreover, a link efficiency control driver 280 provides another interface break signal and data-driving capability for a transmission efficiency of the base band transmitter unit 140 or the radio frequency transmitter unit 150. Moreover, a link quality monitor driver 290 provides another interface break signal and data-driving capability for a transmission efficiency of the base band receiver unit 170 or the radio frequency receiver unit 160.

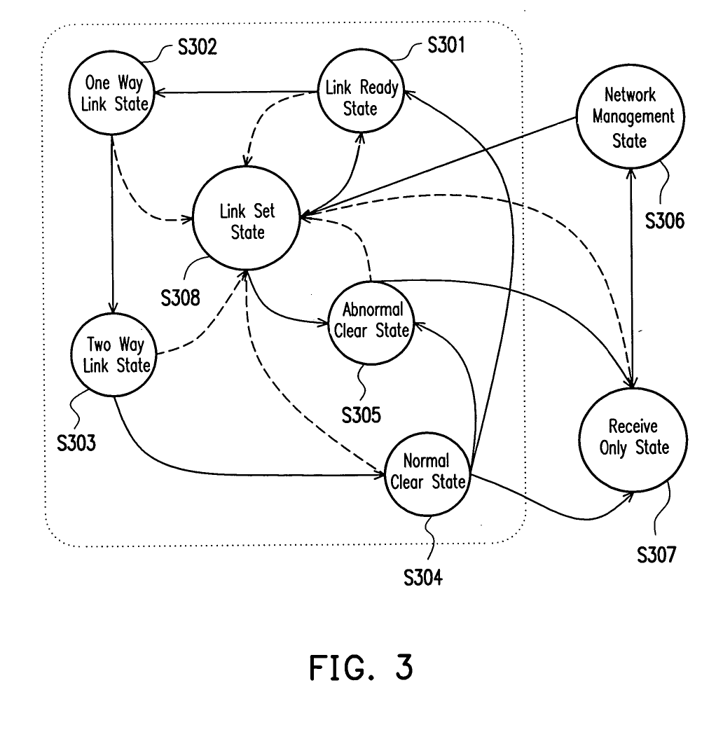

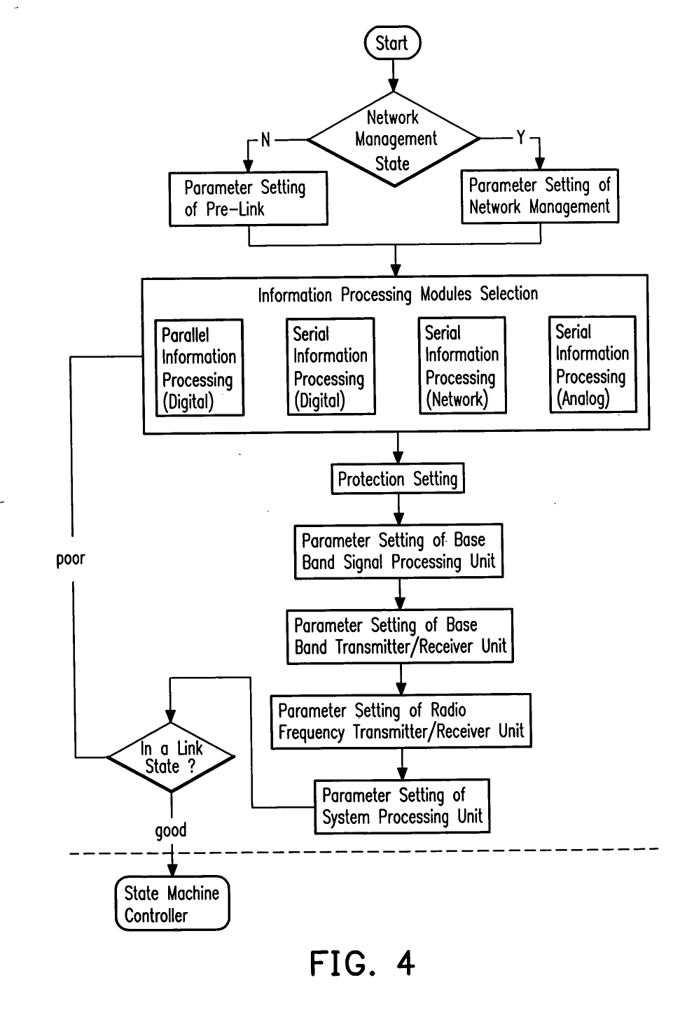

FIG. 3 illustrates states of a state machine controller of FIG. 2 as another preferred embodiment of the present invention. Referring to FIG. 3, a solid line represents a change in state during a normal operation. Whereas a dotted line returns a state back to a link set state for a parameter reset when an operation is not operated properly or cannot be maintained. The states are described as follow:
A. link ready state S301: when the set link state is complete and the link is ready for work.
B. one way link state S302: when one party completing a request for the link (the link includes a duplex mode).
C. two ways link state S303: when two parties both completing the request for the link (the link includes a duplex mode).
D. normal clear state S304: when any party completing an information communication by using the link (the link includes a duplex mode).
E. abnormal clear state S305: when the link (the link includes a duplex mode) is terminated before the parties completing the information communication.
F. network set link state S306: for setting a format of information processing and an operational parameter according to the external network thereby providing a normal operation for the state machine.
G. receive only state S307: for prohibiting any party transmitting, but only receiving from the link.
H. set link state S308: for setting a format of information processing, an operational parameter and maintaining a stability; of a link according to a pre-set or a request from the external network. FIG. 4 shows a flow diagram for the link set state of FIG. 3 as another preferred embodiment of the present invention. Referring to FIG. 4, the flow includes: network management state (by a pre-set or an external network management); information processing modulation selection and setting (including serial and parallel, analog and digital information and network management information selection); protection setting; base band information; base band/radio frequency transmitter/receiver unit; and parameter setting of the system processing unit. In addition, the set link state 308 monitors and maintains a stability of the link by using a feedback.

Referring to both FIG. 1A and FIG. 1B, the base band transmitter unit 140 uses a data and a parameter set from the system control unit 110 to frame a data according to a frame format. In addition, the base band transmitter unit 140 incorporates a function for forward error correction and a function for adjusting the bandwidth (or chip length) for a direct sequence spread spectrum. Thus, the base band transmitter unit 140 provides multiple applied functions for multiple users simultaneously. Finally, the base band transmitter unit 140 converts the framed data to a base band analog signal as an input for the radio frequency transmitter unit 150. The base band transmitter unit 140 includes an interface controller 141, a framer 142, an error correction encoder 143, a spreader 144 and a digital-to-analog converter 145. The interface controller 141 is capable of choosing and setting the parameters of the interfaces for the base band transmitter unit 140. For example, a frame format selection and setting for the framer 142, or a parameter selection and setting for a scrambler, Reed-Solomon coding, an interleaver, convolutional coding, differential coding, or a spreader 144.

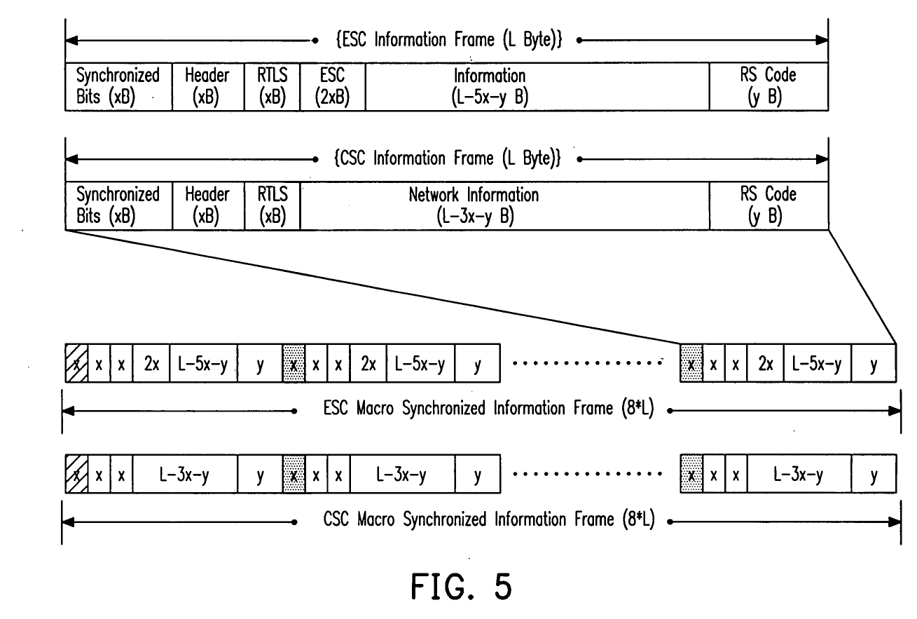

The framer 142 frames a data into a fixed length size from an interface integration driving unit 114. In which, the data within the framed data can be different in sizes. FIG. 5 shows an ESC/CSC information frame and an ESC/CSC macro synchronized information frame as another preferred embodiment of the present invention. Referring to FIG. 5, a frame includes two formats: an embedded signal channel (ESC) and a common signal channel (CSC). The main use of the ESC frame is to transmit a traffic information. On the other hand, the main use of the CSC frame is to transmit a network management information. Moreover, the ESC frames (or CSC frames) can be combined to form an ESC (or CSC) macro-synchronized information frame. Each of the ESC (or CSC) macro-synchronized information frames includes a number of ESC (or CSC) frames, for example, 8 ESC frames, for providing a macro synchronized information of a framer thereby adjusting the quality of the link.

The error correction encoder 143 includes a scrambler and an interleaver and functions, for example, Reed-Solomon coding, convolutional coding and differential coding for organizing the frame received into a code information data having an error correction capability. Moreover, the spreader 144 is capable of generating a plurality of data packets from the code information data (from the error correction encoder 143) according to a direct sequence of different chip lengths. The data packets can be of different sizes. Moreover, the digital to analog converter 145 is capable of converting the data packets to the base band analog signal.

The base band receiver unit 170 is used to convert an input base band analog signal to a digital signal. In addition, the base band receiver unit 170 is capable of decoding the spread spectrum, decoding the forward error correction, and de-framing a data from a frame. The base band receiver unit 170 includes an interface controller 171, an analog to digital converter 172, a de-spreader 173, an error correction decoder 174 and a de-framer 175. The interface controller 171 is capable of choosing and setting the parameters of the interfaces for the base band receiver unit 170. For example, a frame format selection and setting for the de-framer 175, or a parameter selection and setting for a de-spreader 173, differential decoding, Viterbi decoding, a de-interleaver, de-Reed-Solomon coding or a de-scrambler.

The analog to digital converter 172 is capable of converting the base band analog signal to a data packet. The de-spreader 173 is capable of converting a plurality of the data packets to another code information data. The error correction decoder 174 is capable of decoding the code information data received to another frame. The error correction decoder 174 includes differential decoding, Viterbi decoding, a de-interleaver, de-Reed-Soloman coding and a de-scrambler.

The de-framer 175 is capable of converting the frame to a data before transmitting to the interface integration driving unit 114. FIG. 5 shows an ESC/CSC information frame and an ESC/CSC macro synchronized information frame as another preferred embodiment of the present invention. Referring to FIG. 5, a frame includes two formats: an embedded signal channel (ESC) and a common signal channel (CSC). The main use of the ESC frame is to transmit a traffic information. On the other hand, the main use of the CSC frame is to transmit a network management information. Moreover, the ESC frames (or CSC frames) can be combined to form an ESC (or CSC) macro-synchronized information frame. Each of the ESC (or CSC) macro-synchronized information frames includes a number of ESC (or CSC) frames, for example, 8 ESC frames, for providing a macro synchronized information of a de-framer thereby adjusting the quality of the link.

The system processing unit is capable of providing a reference signal according to a plurality of applied parameters of the system control unit 110, the base band signal processing unit 130, the base band transmitter unit 140 and the base band receiver unit 170. In which the reference signal is programmable to at least one of the base band signal processing unit, the system control unit capable, the base band transmitter and the base band receiver unit. A chip rate and a sampling rate corresponding to the chip rate are changeable according to different parameters including input data rate, Reed-Soloman code, convolutional code and spread spectrum code. The system processing unit includes: a system reference control processor 120; an information pulse generator 118; a chipping pulse generator 148 and a chipping sample pulse generator 178. The system reference control processor 120 coordinates, manages and outputs a pulse required for each unit within the apparatus. The information pulse generator 118 generates a required reference pulse for each of the system control unit 110 and the base band signal processing unit 130. The chipping pulse generator 148 generates a required reference pulse for the base band transmitter unit 140. The chipping sample pulse generator 178 generates a required reference pulse for the base band receiver unit 170.

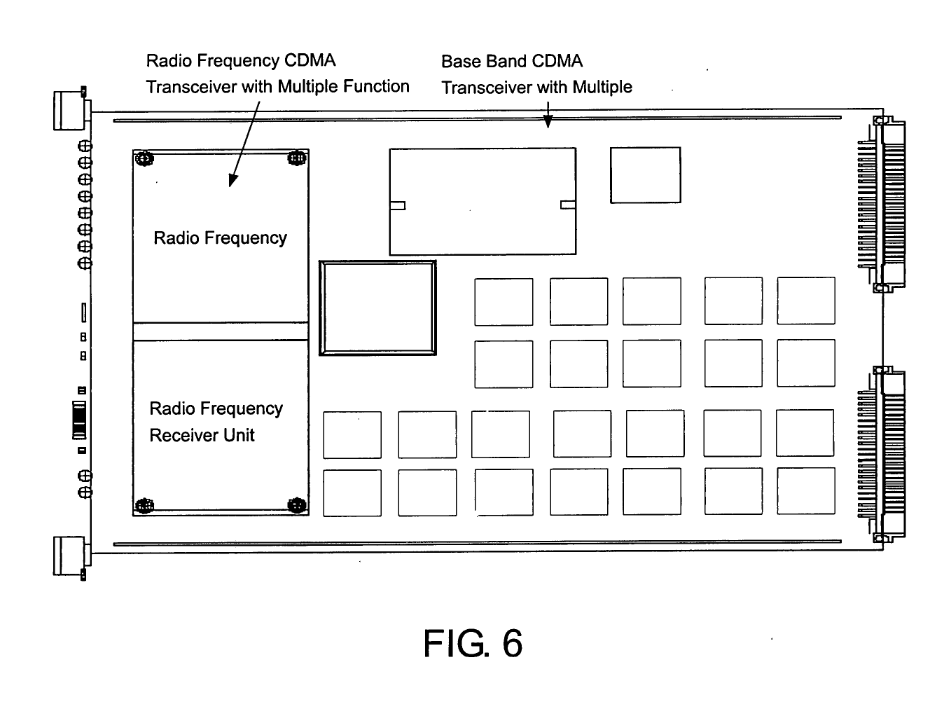

FIG. 6 illustrates a radio frequency CDMA transceiver with multiple functions and a base band CDMA transceiver with multiple functions as another preferred embodiment of the present invention. Referring to FIG. 6, the radio frequency transmitter unit 150 and the radio frequency receiver unit 160 can be fixed by four screws on a circuit board of the base band transmitter unit 140 and the base band receiver unit 170.

The radio frequency transmitter unit 150 is capable of converting the base band analog signal and providing a radio frequency signal for transmitting. In addition, the radio frequency transmitter unit 150 is capable of adjusting a work efficiency of a transmitting signal, selecting and setting a band frequency, and selecting and setting a bandwidth of a base band (and a radio frequency). Moreover, the radio frequency transmitter unit 150 includes a gain control functionality to adjust the actual output work efficiency of the spread spectrum. Moreover, the radio frequency transmitter unit 150 is designed to be a module and is coupled on the circuit board of the base band transmitter unit 140 and the base band receiver unit 170. The radio frequency transmitter unit 150 includes an interface controller 151, a low pass filter 152, an oscillating generator 153, a band pass filter 154 and an operational amplifier 155. The interface controller 151 is capable of choosing and setting a plurality of interface related parameters for the radio frequency transmitter unit 150. The parameters can be, for example, a cutoff frequency for the low pass filter 152, frequency setting of the oscillating generator 153, selecting and setting for the band pass filter 154 and a gain control for the operational amplifier 155. The low pass filter 152 is capable of selecting and setting the bandwidth of the base band analog signal. The oscillating generator 153 is capable of providing a programmable stable signal source for adjusting a signal from the low pass filter. The band pass filter 154 is capable of selecting and setting the bandwidth of the radio frequency signal. Finally, the operational amplifier 155 is capable of amplifying and controlling the radio frequency signal for an output.

The radio frequency receiver unit 160 is capable of receiving the radio frequency signal from the outside and re-converting back to the base band analog signal. In addition, the radio frequency receiver unit 160 is capable of adjusting a work efficiency and a gain of a receiving signal, selecting and setting a band frequency, and selecting and setting a bandwidth of a base band (and a radio frequency). Moreover, the radio frequency receiver unit 160 includes an automatic gain control (AGC) capability. A mid band signal from a spread spectrum is adjusted to a base band spectrum signal by the automatic gain control before an analog signal converter. Moreover, the radio frequency receiver unit 160 is designed to be a module and is also coupled on the circuit board of the base band transmitter unit 140 and the base band receiver unit 170. The base bandreceiver unit 160 includes an interface controller 161, an operational amplifier 162, a band pass filter 163, an oscillating generator 164 and a low pass filter 165. The interface controller 161 is capable of choosing and setting a plurality of interface related parameters for radio frequency receiver unit 160. The parameters can be, for example, a cutoff frequency for the low pass filter 165, frequency setting of the oscillating generator 164, selecting and setting for the band pass filter 163 and a gain control for the operational amplifier 162. The operational amplifier 162 is capable of amplifying and controlling the radio frequency signal from an input. The band pass filter 163 is capable of selecting and setting the bandwidth of the radio frequency signal. The oscillating generator 164 is capable of providing a programmable stable signal source for adjusting a signal from the band pass filter. The low pass filter 165 is capable of selecting and setting the bandwidth of the base band analog signal.

The experimental data of the present embodiment of the invention is mainly conducted by empirical study and proof to demonstrate the functionality and advantages of the invention. The CDMA transmitting and receiving apparatus can be implemented by two main parts namely a multiple applied functions base band CDMA transceiver and a multiple applied functions radio frequency CDMA transceiver as illustrated in FIG. 6. The multiple applied functions base band (or radio frequency) CDMA transceiver is responsible for transmitting and receiving signals of the base band and the spread spectrum, and is capable of providing multiple functions for an interface of an end user terminal, for example, a voicemail, a fax, an exchanger, a network, an external protected device and an interface of a multiple functions radio frequency terminal.

The base band signal processing unit 130 is implemented through a chip capable of processing a voicemail and a fax, an I/O output serial communication port, a signal and information driver and a memory. The base band transmitter unit 140 and the base band receiver unit 170 can be implemented through digital signal processing (DSP), field programmable gate array (FPGA) and other related chips. The radio frequency transmitter unit 150 and the radio frequency receiver unit 160 can be implemented through a radio frequency related technology circuitry and a chip thereof. Moreover, the system processing unit can be implemented through a programmable numerical controlled oscillator (NCO) and other related filters. Moreover, the system control unit 110 can be implemented through an embedded real time micro-processor. For example, the MC68 series, a memory device and other related chips according to a specified format for transmission and by using a state machine for control and integration coupled to a network management unit, the base band signal processing unit 130 and the base band (and radio frequency) transmitter (and receiver) units 140-170. Thus, the system control unit 110 is able to provide an applied interface for the network management unit, and information processing and communication through an interface to the outside, and internal control of an operation and the parameters for each unit.

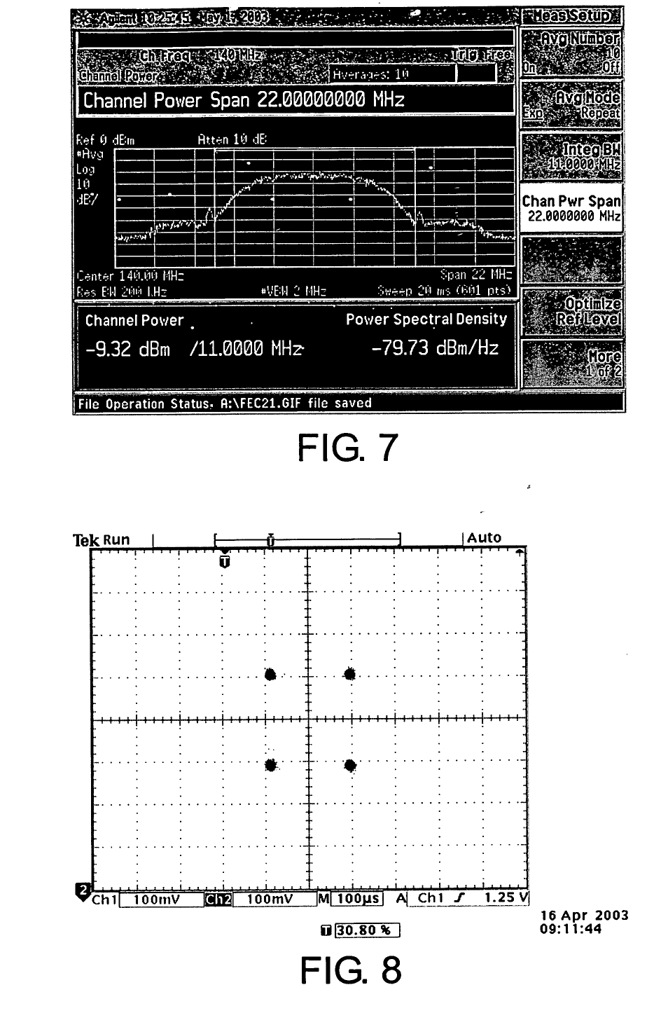

To summarize, the embodiments of the present invention can be applied to a VSAT CDMA communication system. In addition, the apparatus and the method thereof are able to meet the demands for multiple functions of a CDMA communication system at the same time resolve many of the communication difficulties. For example, an exchanger, a phone, a fax, a data from a network management, an external protected device and a common serial/parallel input data transmission. Here are partial results of the experimentation for referencing. The data represent different output spectrums and input constellation diagrams according to different parameter sets. FIG. 7 shows an output spread spectrum (F_{c}=140 MHz, FEC=½, Powers≅−10 dbm, F_{c,cut}≅4.4 MHz, PN length=512) as another preferred embodiment of the present invention. FIG. 8 shows an output spread spectrum (F_{c}=140 MHz, FEC=½, Power≅−40 dbm, F_{c,cut}≅4.4 MHz, PN length=512) as another preferred embodiment of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A code division multiple access (CDMA) transmitting and receiving apparatus with multiple applied interface functions, comprising:
a base band signal processing unit capable of converting a variety of analog or digital input data in serial or parallel to a base band data;
a system control unit capable of setting, changing, monitoring and maintaining a communication link by organizing the base band data according to an outside setting or an internal setting of the apparatus, and integrating a plurality of controllers and a plurality of interface drivers internal and external to the apparatus thereby outputting a code data and a setting parameter;
a base band transmitter unit electrically coupling to the system control unit capable of framing the code data according to the setting parameter and outputting a base band analog signal;
a base band receiver unit electrically coupling to the system control unit capable of processing and de-framing a base band analog signal from the outside according to the setting parameter and outputting a base band digital signal to the system control unit; and
a system processing unit capable of providing a reference signal according to a plurality of applied parameters of the system control unit, wherein the reference signal is programmable to at least one of the base band signal processing unit, the system control unit, the base band transmitter and the base band receiver unit.

2. The code division multiple access (CDMA) transmitting and receiving apparatus with multiple applied interface functions of claim 1, wherein the base band signal processing unit comprises:
an analog signal interface converter capable of converting an input of an analog signal from a first applied interface of the outside to the base band data and outputting the base band data, or alternatively, converting an input of the base band data to the analog signal of the first applied interface and outputting the analog signal of the first applied interface to the outside; and
a serial communication processor capable of converting an input of a digital signal from a second applied interface of the outside to the base band data and outputting the base band data, or alternatively, converting an input of the base band data to the digital signal of the second applied interface and outputting the digital signal of the second applied interface to the outside.

3. The code division multiple access (CDMA) transmitting and receiving apparatus with multiple applied interface functions of claim 2, wherein the analog signal from the first applied interface comprises a signal from a voicemail, a fax or an exchanger.

4. The code division multiple access (CDMA) transmitting and receiving apparatus with multiple applied interface functions of claim 2, wherein the digital signal from the second applied interface comprises a signal from a network, an external protected device or a common serial/parallel output device.

5. The code division multiple access (CDMA) transmitting and receiving apparatus with multiple applied interface functions of claim 1, wherein the system control unit comprises:
an interface integration driving unit capable of integrating a plurality of interfaces of the apparatus according to an internal setting;
a network layer management unit capable of setting, changing, monitoring and maintaining the communication link according to a parameter from an external network management system; and
a data storage exchange unit capable of exchanging parameters of the interfaces of the apparatus, and transmitting and exchanging network information.

6. The code division multiple access (CDMA) transmitting and receiving apparatus with multiple applied interface functions of claim 5, wherein the interface integration driving unit comprises:
a plurality of interface drivers capable of driving the parameters exchange of the interfaces of the apparatus, and the transmission and exchange of network information and break thereafter; and
a state machine controller having a state machine and a plurality of states, capable of setting and managing the interface drivers,-and using the state machine for avoiding the interfaces having an unstable state or a transient state.

7. The code division multiple access (CDMA) transmitting and receiving apparatus with multiple applied interface functions of claim 6, wherein the states of the state machine controller comprise:
a set link state for setting a format of information processing, an operational parameter and maintaining a stability of a link according to a pre-set or a request from the external network;
a link ready state when the set link state is complete and the link is ready for work;
an one way link state when one party completing a request for the link;
a two ways link state when two parties both completing the request for the link;
a normal clear state when any party completing an information communication by using the link;
an abnormal clear state when the link is terminated before the parties completing the information communication;
a network set link state for setting a format of information processing and an operational parameter according to the external network thereby providing a normal operation for the state machine; and
a receive only state for prohibiting any party transmitting, but only receiving from the link.

8. The code division multiple access (CDMA) transmitting and receiving apparatus with multiple applied interface functions of claim 1, wherein the base band transmitter unit comprises:
an interface controller capable of choosing and setting the parameters of the interface for the base band transmitter unit;
a framer capable of putting a data into a frame;
an error correction encoder capable of organizing the frame received into a code information data having an error correction capability;
a spreader capable of generating a plurality of data packets from the code information data; and
a digital to analog converter capable of converting the data packets to the base band analog signal.

9. The code division multiple access (CDMA) transmitting and receiving apparatus with multiple applied interface functions of claim 8, wherein the error correction encoder comprises a scrambler, a Reed-Soloman encoder, an interleaver and a convolutional encoder.

10. The code division multiple access (CDMA) transmitting and receiving apparatus with multiple applied interface functions of claim 1, wherein the base band receiver unit comprises:
an interface controller capable of choosing and setting the parameters of the interface for the base band receiver unit;
an analog to digital converter capable of converting the base band analog signal to a data packet;
a de-spreader capable of converting a plurality of the data packets to a code information data;
an error correction decoder capable of decoding the code information data received to a frame; and
a de-framer capable of converting the frame to a data.

11. The code division multiple access (CDMA) transmitting and receiving apparatus with multiple applied interface functions of claim 10, wherein the error correction decoder comprises a de-scrambler, a Reed-Soloman decoder, a de-interleaver and a Viterbi decoder.

12. The code division multiple access (CDMA) transmitting and receiving apparatus with multiple applied interface functions of claim 1, wherein the system processing unit comprises:
a system reference control processor capable of coordinating and administering the reference signal for each of the units of the apparatus;
an information pulse generator capable of generating the reference signal for the system control unit and the base band signal processing unit;
a chipping pulse generator capable of generating the reference signal for the base band transmitter unit; and
a chipping sample pulse generator capable of generating the reference signalf or the base band receiver unit.

13. The code division multiple access (CDMA) transmitting and receiving apparatus with multiple applied interface functions of claim 1, wherein the apparatus further comprises:
a radio frequency (RF) transmitter unit capable of converting the base band analog signal and providing a radio frequency signal for transmitting; and
a radio frequency (RF) receiver unit capable of receiving the radio frequency signal from the outside and re-converting back to the base band analog signal.

14. The code division multiple access (CDMA) transmitting and receiving apparatus with multiple applied interface functions of claim 13, wherein the radio frequency transmitter unit comprises:
an interface controller capable of choosing and setting a plurality of interface related parameters for the radio frequency transmitter unit;
a low pass filter capable of selecting and setting the bandwidth of the base band analog signal;
an oscillating generator capable of providing a programmable stable signal source for adjusting a signal from the low pass filter;
a band pass filter capable of selecting and setting the bandwidth of the radio frequency signal; and
an operational amplifier capable of amplifying and controlling the radio frequency signal for an output.

15. The code division multiple access (CDMA) transmitting and receiving apparatus with multiple applied interface functions of claim 13, wherein the radio frequency receiver unit comprises:
an interface controller capable of choosing and setting a plurality of interface related parameters for radio frequency receiver unit;
an operational amplifier capable of amplifying and controlling the radio frequency signal from an input;
a band pass filter capable of selecting and setting the bandwidth of the radio frequency signal;
an oscillating generator capable of providing a programmable stable signal source for adjusting a signal from the band pass filter; and
a low pass filter capable of selecting and setting the bandwidth of the base band analog signal.

16. A code division multiple access (CDMA) transmitting and receiving apparatus with multiple applied interface functions, comprising:
an interface integration driving unit capable of providing and coordinating a plurality of interfaces for internal and external connection of the apparatus according to a pre-set, and integrating a plurality of applied signal sources, a plurality of signal transmitting units and a plurality of signal receiving units;
a network layer management unit capable of managing the interface integrating driving unit according to the pre-set, and setting, changing, monitoring and maintaining a communication link; and
a data storage exchange unit capable of exchanging parameters of the interfaces of the apparatus, and transmitting and exchanging network information.

17. The code division multiple access (CDMA) transmitting and receiving apparatus with multiple applied interface functions of claim 16, wherein the interface integration driving unit comprises:
a plurality of interface drivers, wherein each of the interface drivers is electrically coupled to the applied signal sources, the signal transmitting units and the signal receiving units, and is capable of driving each of the interfaces for information communication; and
a state machine controller having a state machine and a plurality of states, capable of setting and managing the interface drivers, and using the state machine for avoiding the interfaces having an unstable state or a transient state.

18. The code division multiple access (CDMA) transmitting and receiving apparatus with multiple applied interface functions of claim 17, wherein the states of the state machine controller comprise:
a set link state for setting a format of information processing, an operational parameter and maintaining a stability of a link according to a pre-set or a request from the external network;
a link ready state when the set link state is complete and the link is ready for work;
an one way link state when one party completing a request for the link;
a two ways link state when two parties both completing the request for the link;
a normal clear state when any party completing an information communication by using the link;
an abnormal clear state when the link is terminated before the parties completing the information communication;
a network set link state for setting a format of information processing and an operational parameter according to the external network thereby providing a normal operation for the state machine; and
a receive only state for prohibiting any party transmitting, but only receiving from the link.

19. The code division multiple access (CDMA) transmitting and receiving apparatus with multiple applied interface functions of claim 16, wherein the applied signal sources comprise a signal from a voicemail, a fax, an exchanger, a network, an external protected device and a common serial/parallel output device.

20. A method for making a code division multiple access (CDMA) transmitting and receiving apparatus with multiple applied interface functions, comprising:
clearing all first links;
waiting for a request signal from a plurality of applied interfaces or a plurality of communication interfaces;
executing a state exchange mechanism according to the request signal for building a second link for transmission the request signal at the same time executing a step of the request signal; and
clearing the second link according to the state exchange mechanism.

21. The method for making a code division multiple access (CDMA) transmitting and receiving apparatus with multiple applied interface functions of claim 20, wherein the state machine mechanism comprises:
a set link state for setting a format of information processing, an operational parameter and maintaining a stability of a link according to a pre-set or a request from the external network;
a link ready state when the set link state is complete and the link is ready for work;
an one way link state when one party completing a request for the link;
a two ways link state when two parties both completing the request for the link;
a normal clear state when any party completing an information communication by using the link;
an abnormal clear state when the link is terminated before the parties completing the information communication;
a network set link state for setting a format of information processing and an operational parameter according to the external network thereby providing a normal operation for the state machine; and
a receive only state for prohibiting any party transmitting, but only receiving from the link.
